(19) United States
(12) Patent Application Publication
(10) Pub. No.: US 2012/0222905 A1
(43) Pub. Date: Sep. 6, 2012

(54) Portable Electronic Device Able To Measure Weight

(75) Inventor: Wen-Hung Huang, Taipei County (TW)

(73) Assignee: HANNSPREE, INC., Taipei County (TW)

(21) Appl. No.: 13/161,374

(22) Filed: Jun. 15, 2011

(30) Foreign Application Priority Data
Mar. 3, 2011 (TW) 100107234

(51) Int. Cl. G01G 9/00

(52) U.S. Cl. 177/210 R; 177/201

(57) ABSTRACT

A portable electronic device able to measure weight comprises an electronic device having a first body member and a second body member, a weight sensor and a display panel. One side of the first body member and one side of the second body member are pivotally coupled to at least one connecting member. The weight sensor is arranged inside the second body member and weighs an object on top of the first body member. The display panel is disposed on the first body member and displays weight data detected by the weight sensor.

### BACKGROUND OF THE INVENTION

1. Field of the Invention

The present invention relates to a portable electronic device, such as a notebook computer, a music player or a game machine, particularly to a portable electronic device able to measure weight.

2. Description of the Related Art

Many portable electronic devices, such as notebook computers are indispensable in everyday living. Thus, many manufacturers persistently develop accessories for portable electronic devices to increase the utility and value thereof.

Bathroom scales and platform scales are often required in everyday life. However, they are hard to carry about and not always ready in all occasions, such as in an outdoor activity, Bathroom scales and platform scales are only placed at home or the working place. Therefore, it is necessary to propose an approach to measure weight in all situations and at any places.

### SUMMARY OF THE INVENTION

The primary objective of the present invention is to incorporate a weight-measuring function to a portable device, which is indispensable for people in everyday living, whereby the user not only can enjoy the function of the portable device but also can use it to measure weight.

In order to achieve the abovementioned objective, the present invention proposes a portable electronic device able to measure weight, which comprises an electronic device, a weight sensor and a display panel. The electronic device has a first body member and a second body member. One side of the first body member and one side of the second body member are pivotally coupled to at least one connecting member. The first body member is positioned on top of the second body member and has a platform able to carry an object to be measured. The weight sensor is disposed on the bottom of the second body member, weighing the object carried by the platform of the first body member. The display panel displays the data obtained by the weight sensor.

In one embodiment, the first body member can be pivotally lifted up from the second body member with the connecting members being the pivotal axis.

In one embodiment, the connecting members enable the first body member to slide parallel with respect to the second body member.

In one embodiment, the display panel is disposed on a first upper surface of the first body member.

In one embodiment, at least one control key is arranged on the first body member.

In one embodiment, the weight sensor includes a plurality of weight transducers respectively disposed at the bottoms of the corners of the second body member.

In one embodiment, the first body member has a first casing, and the first casing has a plurality of first upper support ribs and a plurality of first lower support ribs.

In one embodiment, the first casing has a first upper casing and a first lower casing; the first upper casing is joined to the first lower casing; the first upper support ribs are arranged on one surface of the first upper casing, which faces the first lower casing; the first lower support ribs are arranged on one surface of the first lower casing, which faces the first upper casing; the first upper support ribs neighbor the first lower support ribs; the first upper support ribs support against the first lower casing; the first lower support ribs support against the first upper casing, whereby is supported the first upper surface.

In one embodiment, the second body member has a second casing, and the second casing has a plurality of second upper support ribs and a plurality of second lower support ribs.

In one embodiment, the second casing has a second upper casing and a second lower casing; the second upper casing is joined to the second lower casing; the second upper support ribs are arranged on one surface of the second upper casing, which faces the second lower casing; the second lower support ribs are arranged on one surface of the second lower casing, which faces the second upper casing; the second upper support ribs neighbor the second lower support ribs; the second upper support ribs support the second lower casing; the second lower support ribs support against the second upper casing, whereby is supported the first body member.

In one embodiment, the electronic device is a notebook computer, a mobile communication device, a personal digital assistant, a music player, or a game machine.

### BRIEF DESCRIPTION OF THE DRAWINGS

FIGS. 1A-1D are perspective views of a portable electronic device able to measure weight according to embodiments of the present invention;

FIG. 2 is a top view of a first body member of a portable electronic device able to measure weight according to one embodiment of the present invention;

FIG. 3 is a front view of a first body member of a portable electronic device able to measure weight according to one embodiment of the present invention;

FIG. 4A is a partial sectional view along Line 4-4 in FIG. 2; and

FIG. 4B is a partially enlarged view of the region encircled by the dashed line in FIG. 4A.

### DETAILED DESCRIPTION OF THE INVENTION

Below, the embodiments are described in detail to demonstrate the technical contents of the present invention.

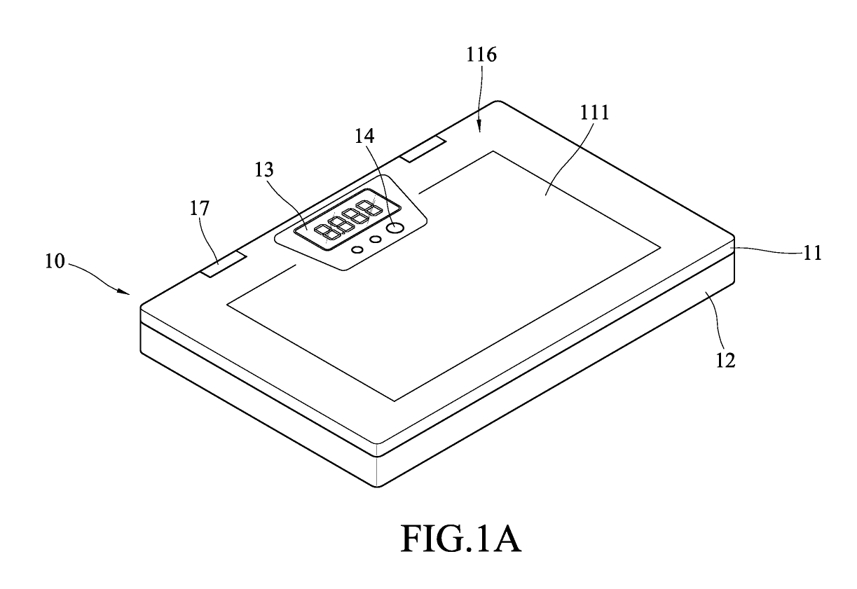

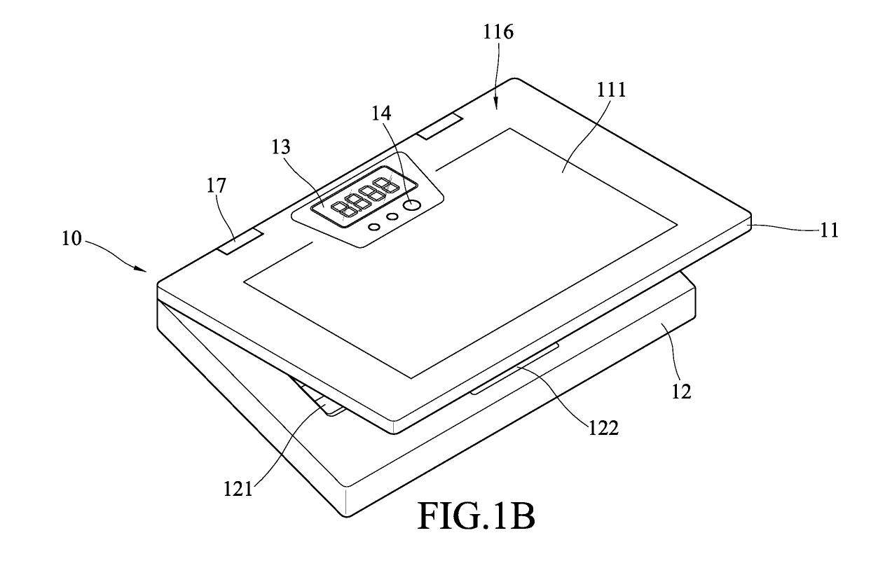

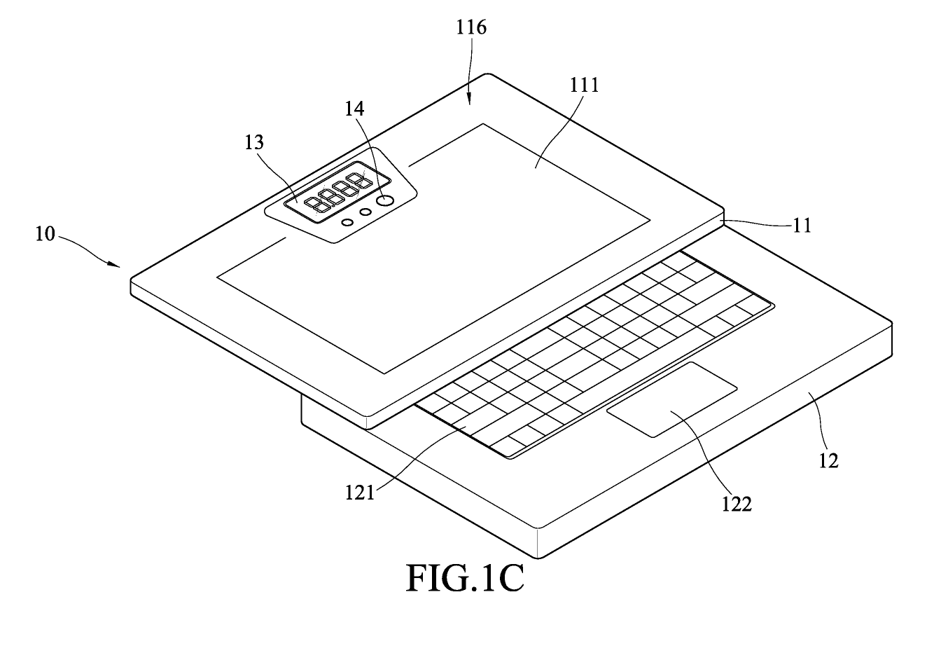

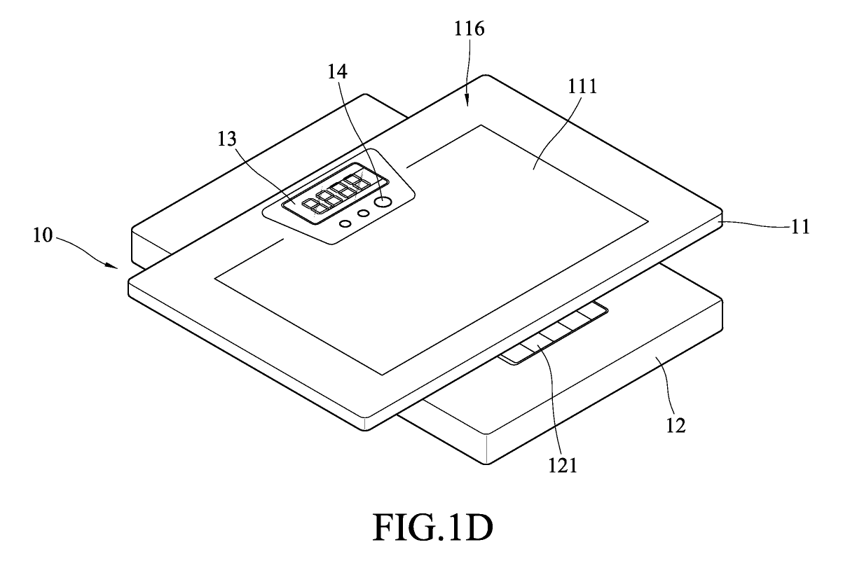

Refer to FIG. 1A and FIG. 3 respectively a perspective view and a side view of a portable electronic device able to measure weight according to one embodiment of the present invention. The portable electronic device able to measure weight of the present invention comprises an electronic device 10, a weight sensor 16 and a display panel 13. The electronic device 10 includes a first body member 11 and a second body member 12. It should be particularly explained that the electronic device 10 is a notebook computer, a mobile communication device, a personal digital assistant, a music player, or a game machine.

One side of the first body member 11 and one side of the second body member 12 are pivotally coupled to at least one connecting member 17. The connecting members 17 are assembled to the first body member 11 and the second body member 12 in a specified way (as shown in FIG. 1A). In one embodiment, the first body member 11 is positioned on the second body member 12, as shown in FIG. 1A. Via the connecting members 17, one side of the first body member 11 can be pivotally lifted up with respect to the second body member 12 to a specified angle, as shown in FIG. 1B. In one embodiment, the first body member 11 is able to slide parallel with respect to the second body member 12, as shown in FIG. 1C. In one embodiment, the first body member 11 is able to rotate with respect to the second body member 12 on an identical plane, as shown in FIG. 1D.

The first body member 11 has a first upper surface 116, which is locally or completely flat. The first upper surface 116 has a platform 111 carrying an object, whose weight is to be measured by the electronic device 10.

In FIG. 1A, the electronic device 10 is exemplified by a notebook computer. The display panel 13 is arranged on the top edge of the platform 111, displaying the weight data of the object carried by the platform 111. At least one control key 14, such as a power switch, is arranged in the perimeter of the display panel 13.

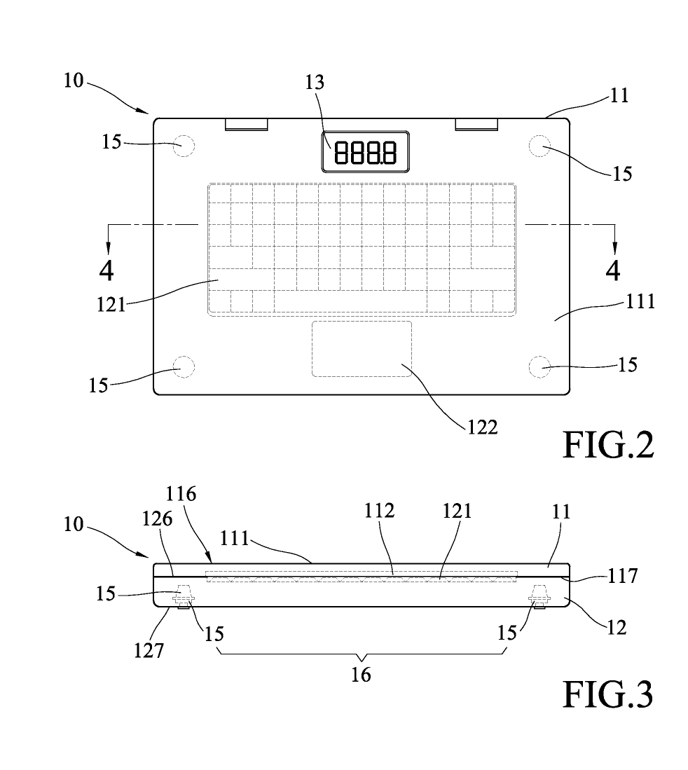

Refer to FIG. 2 and FIG. 3. FIG. 2 is a top view of a first body member of a portable electronic device able to measure weight according to one embodiment of the present invention. FIG. 3 is a front view of a portable electronic device able to measure weight according to one embodiment of the present invention. A screen 112 is arranged on a first lower surface 117 of the first body member 11. A keyboard 121 and a touchpad 122 are arranged on a second upper surface 126 of the second body member 12. The weight sensor 16 is disposed inside the second body member 12 and used to weigh the object on top of the platform 111. The weight sensor 16 has four weight transducers 15 arranged at four corners of a second lower surface 127 of the second body member 12. The weight transducers 15 measure the weight of the object on top of the platform 111 and transmit the weight signal to the display panel 13. The display panel 13 receives the weight signal in a wired way or a wireless way and displays data of the weight.

When intending to measure weight, the user operates the first body member 11 to coincide with the second body member 12 and turns on the power. When an object is placed on the platform 111 or an external force is applied to the platform 111, the display panel 13 displays the data of weight. The data is not limited to numerals but may alternatively be symbols or pictures.

For the user, the notebook computer is not only a computer but also an electronic platform scale or an electronic bathroom scale. The user not only can enjoy the function of a computer but also can use it to measure weight.

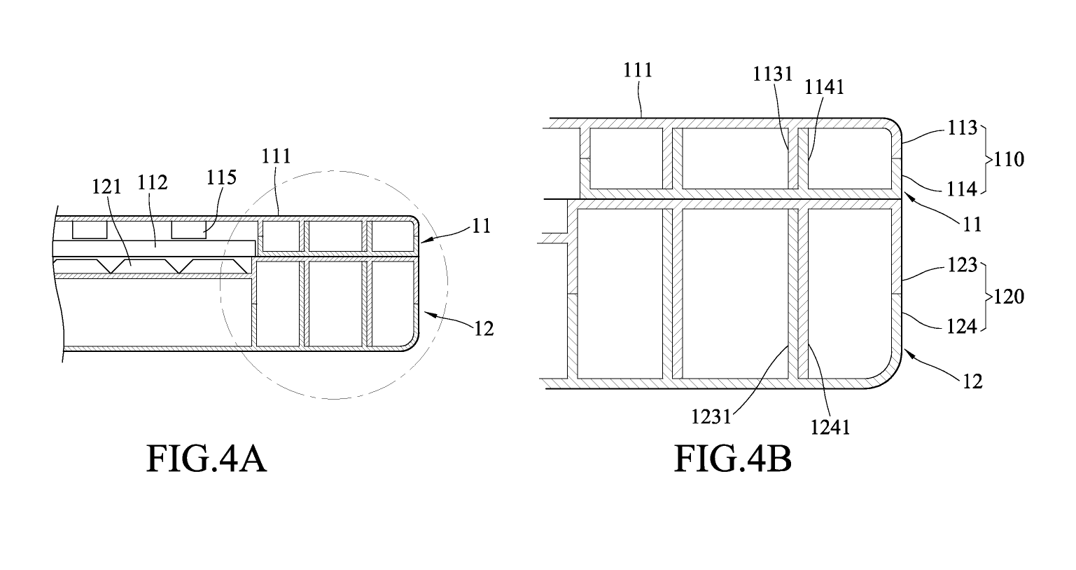

Refer to FIGS. 4A and 4B shows the internal structure of the first body member 11 and second body member 12. FIG. 4A is a partial sectional view along Line 4-4 in FIG. 2. FIG. 4B is a partially enlarged view of the region encircled by the dashed line in FIG. 4A. In one embodiment, the first body member 11 and the second body member 12 adopt the structure shown in FIGS. 4A and 4B, wherein the first body member 11 has a first casing 110 and the second body member 12 has a second casing 120. In order to enhance the structure of the electronic device 10, the first casing 110 of the first body member 11 and the second casing 120 of the second body member 12 are made of a material having high hardness and uneasy to crack, such as a graphite-reinforced material or a glass fiber-reinforced material, lest the first body member 11 and second body member 12 be deformed or damaged by the object having a considerable weight placed on top of platform 111. The first casing 110 further has a first upper casing 113 and a first lower casing 114. The second casing 120 further has a second upper casing 123 and a second lower casing 124.

The first casing 110 has a plurality of first upper support ribs 1131 and a plurality of first lower support ribs 1141. The first upper casing 113 is joined with the first lower casing 114. The first upper support ribs 1131 are arranged on one surface of the first upper casing 113, which faces the first lower casing 114. The first lower support ribs 1141 are arranged on one surface of the first lower casing 114, which faces the first upper casing 113. When the first upper casing 113 is joined to the first lower casing 114, the first upper support ribs 1131 are adjacent to the first lower support ribs 1141 and support the first lower casing 114, and the first lower support ribs 1141 support the first upper casing 113. Thereby, the first upper surface 116 is supported by the abovementioned structure.

The second casing 120 has a plurality of second upper support ribs 1241 and a plurality of second lower support ribs 1231. The second upper ribs 1241 are arranged on one surface of the second upper casing 123, which faces the second lower casing 124. The second lower support ribs 1231 are arranged on one surface of the second lower casing 124, which faces the second upper casing 123. The second upper support ribs 1241 neighbor the second lower support ribs 1231. When the second upper casing 123 is joined to the second lower casing 124, the second upper support ribs 1241 support the second lower casing 124, and the second lower support ribs 1231 support the second upper casing 123. Thereby, the first member 11 is supported by the abovementioned structure.

In order to enhance the strength of a large area, a plurality of support ribs 115 may be arranged inside the first casing 110 and the second casing 120 to support the area.

The embodiments described above are only to exemplify the present invention but not to limit the scope of the present invention. Any equivalent modification or variation according to the claims and specification of the present invention is to be also included within the scope of the present invention.

What is claimed is:

1. A portable electronic device able to measure weight comprising:
an electronic device including a first body member and a second body member, wherein one side of said first body member and one side of said second body member are pivotally coupled to at least one connecting member, and wherein said first body member is positioned on said second body member, and wherein said first body member has a platform where an object to be measured is placed;
a weight sensor arranged inside said second body member; and
a display panel displaying weight data detected by said weight sensor.

2. The portable electronic device able to measure weight according to claim 1, wherein said first body member can be pivotally lifted up from said second body member with said connecting member being a pivotal axis.

3. The portable electronic device able to measure weight according to claim 1, wherein said connecting device enables said first body member to slide parallel with respect to said second body member.

4. The portable electronic device able to measure weight according to claim 1, wherein said display panel is arranged on a first upper surface of said first body member.

5. The portable electronic device able to measure weight according to claim 1, wherein at least one control key is arranged on said first body member.

6. The portable electronic device able to measure weight according to claim 1, wherein said weight sensor includes a plurality of weight transducers respectively arranged at corners of said second body member.

7. The portable electronic device able to measure weight according to claim 1, wherein said first body member has a first casing, and wherein said first casing has a plurality of first upper support ribs and a plurality of first lower support ribs.

8. The portable electronic device able to measure weight according to claim 7, wherein said first casing has a first upper casing and a first lower casing, and wherein said first upper casing is joined to said first lower casing, and wherein said first upper support ribs are arranged on one surface of said first upper casing, which faces said first lower casing, and wherein said first lower support ribs are arranged on one surface of said first lower casing, which faces said first upper casing, and wherein said first upper support ribs neighbor said first lower support ribs, and wherein said first upper support ribs support said first lower casing, and wherein said first lower support ribs support said first upper casing, whereby is supported a first upper surface of said first body member.

9. The portable electronic device able to measure weight according to claim 1, wherein said second body member has a second casing, and wherein said second casing has a plurality of second upper support ribs and a plurality of second lower support ribs.

10. The portable electronic device able to measure weight according to claim 9, wherein said second casing has a second upper casing and a second lower casing, and wherein said second upper casing is joined to said second lower casing, and wherein said second upper support ribs are arranged on one surface of said second upper casing, which faces said second lower casing, and wherein said second lower support ribs are arranged on one surface of said second lower casing, which faces said second upper casing, and wherein said second upper support ribs neighbor said second lower support ribs, and wherein said second upper support ribs support said second lower casing, and wherein said second lower support ribs support against said second upper casing, whereby is supported said first body member.

11. The portable electronic device able to measure weight according to claim 1, wherein said electronic device is a notebook computer, a mobile communication device, a personal digital assistant, a music player, or a game machine.
